(19) United States
(12) Patent Application Publication
(10) Pub. No.: US 2006/0046936 A1
(43) Pub. Date: Mar. 2, 2006

(54) Foliar composition for stressed turfgrass and associated method

(76) Inventors: Travis Teuton, Knoxville, TN (US); John C. Sorochan, Knoxville, TN (US)

Correspondence Address: MICHAEL E. McKEE;Attorney at Law, 804 Swaps Lane, Knoxville, TN, 37923, US

(21) Appl. No.: 10/931,187

(22) Filed: Aug. 31, 2004

(51) Int. Cl. A01N 43/16; A01N 25/26

(52) U.S. Cl. 504/100; 504/292

(57) ABSTRACT

A composition and an associated method for enhancing the growth of turfgrass exposed to or expected to be exposed to appreciable stress utilizes a carbohydrate and an adjuvant for enhancing the absorption of the carbohydrate by the leaves and sheath of the turfgrass. Following the mixing of the carbohydrate and the adjuvant with water, the mixture is applied to the turfgrass so that the carbohydrate of the mixture is applied to the turfgrass at the rate of between about 0.1 gallons and 10 gallons per acre.

### BACKGROUND OF THE INVENTION

This invention relates generally to means and methods for enhancing the growth of turfgrass and relates, more particularly, to a foliar-applied composition and method for enhancing the growth of turfgrass being grown or expected to be grown under stress-inducing conditions.

It is known that any of a number of less-than-optimum growing conditions can induce stress in turfgrass and consequently adversely affect the health and vitality of the turfgrass. Such stress-inducing conditions are those conditions which inhibit naturally-occurring carbohydrate synthesis and/reserves in the turfgrass and include, for example, heat, drought, disease, heavy foot traffic, and a low temperature environment. Furthermore, turfgrass exposed to appreciable stress is likely to be sparse, spindly and exhibit poor color and quality. In contrast, healthy, unstressed turfgrass will normally be dense, and possess a dark green color, leafy foliage and a higher resistance to disease.

It would be desirable to provide a new means and method for enhancing the health and vitality of turfgrass being grown or expected to be grown under stressed conditions.

Accordingly, it is an object of the present invention to provide a new and improved composition which is capable of mixing with water for application to turfgrass, under stress or expected to undergo stress, for enhancing the growth of the turfgrass and an associated method.

Another object of the present invention is to provide such a composition which, when mixed with water, can be spray-applied to the turfgrass.

Yet another object of the present invention is to provide such a composition whose growth-benefiting components are absorbed through the leaves of the turfgrass.

### SUMMARY OF THE INVENTION

This invention resides in a composition and an associated method for enhancing the growth of turfgrass experiencing or expected to experience stress-inducing conditions which inhibit naturally-occurring carbohydrate synthesis or reserves in the turfgrass.

The composition includes a carbohydrate and an adjuvant for enhancing the absorption of the carbohydrate by the leaves and sheath of the turfgrass. When the carbohydrate and adjuvant are mixed with water for application to the turfgrass, the carbohydrate can be applied to the turfgrass at the rate of between about 0.1 gallons and 10 gallons per acre.

The method of the invention includes the steps of providing a carbohydrate and providing an adjuvant for enhancing the absorption of the carbohydrate by the leaves and sheath of the turfgrass. The carbohydrate and adjuvant are then mixed with an amount of water and applied to the turfgrass, experiencing or expected to experience stress, so that the rate at which the carbohydrate of the resulting mixture is applied to the turfgrass is between about 0.1 gallons to 10 gallons per acre.

### BRIEF DESCRIPTION OF THE DRAWINGS

FIG. 1 is a side elevational view illustrating schematically an exemplary turfgrass plant which has been exposed to appreciable stress and before application of the mixture of this invention.

FIG. 2 is a side elevational view of the FIG. 1 turfplant after application of the mixture of this invention.

FIG. 3 is a graph of the experimental test results set forth in Table 1.

### DETAILED DESCRIPTION OF AN ILLUSTRATIVE EMBODIMENT

Common examples of turfgrass with which this invention can be utilized include Creeping Bentgrass, Roughstalk Bluegrass, Annual bluegrass, Centipedegrass, Perennial and annual ryegrass, Supina bluegrass, seashore puspalum, Kentucky bluegrass, tall fescue, St Augustinegrass, Buffalograss, Zoysiagrass and Bermudagrass. When healthy, such turfgrasses are commonly dense and possess a dark green color, leafy foliage and a relatively high resistance to disease. However, when exposed to appreciable stress, the turfgrasses are likely to be sparse, spindly and exhibit poor color and quality.

Since turfgrasses are commonly used in applications, such as on home lawns, golf courses and athletic fields, in which a healthy appearance and performance of the turfgrass is desirable, it is preferable that such a turfgrass possess health and vitality, even when exposed to appreciable stress. As will be apparent herein, the composition of the present invention can be applied to turfgrass experiencing or expected to experience appreciable stress to enhance the health and vitality of the turfgrass, and hence enhance the growth of the turfgrass.

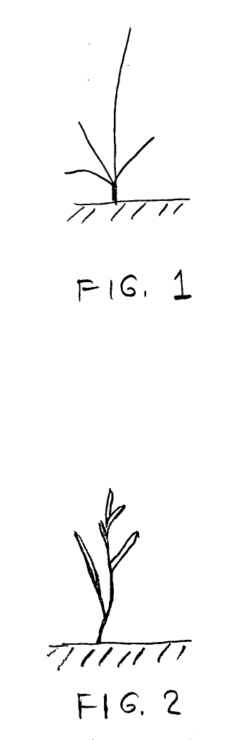

There exists a number of less-than-optimum growing conditions which can induce stress in turfgrass. Such conditions are those conditions which inhibit naturally-occurring carbohydrate synthesis or reserves in the turfgrass and include, for example, heat, drought, disease, heavy foot traffic, and a low temperature environment. Moreover, turfgrass which is exposed to such an appreciable stress is likely to be sparse, spindly and exhibit poor color and quality. For example, there is schematically illustrated in FIG. 1 an example of a sprig of turfgrass (i.e. a bluegrass plant) which has been exposed to appreciable stress. From a physiological standpoint, it can be seen that the FIG. 1 turfplant possesses a relatively spindly stem and its leaves, which are relatively few in number, are relatively thin.

While it is often difficult to quantify the condition of turfgrass under stress, the National Turfgrass Evaluation Program (NTEP) has adopted a visual rating system—utilizing a scale of 1 to 9 wherein one is the poorest or lowest and 9 is the best or highest rating—which provides a measure of the aesthetics (i.e. density, uniformity, texture, smoothness, growth habit and color), and functional use of the turfgrass. With this in mind, turfgrasses with numbers in the lower range of the NTEP scale (i.e. 2-6) exhibit a more pronounced response to treatment with the composition of the present invention than turfgrasses having numbers near the higher range of the NTEP scale (i.e. 7-9). Accordingly, it is preferred that, for best results, the stressed turfgrass to be treated with the composition of the present invention should possess a NTEP rating number of no less than 2. By comparison and to reduce the likelihood that turfgrass which possesses a NTEP rating number at the higher range of the scale will not appreciably drop to a lower rating when subsequently exposed to stressed conditions, such a turfgrass can be treated with the composition of the present invention as a preventative measure (i.e. in advance of exposure to expected conditions of stress). For a more detailed description of the NTEP turfgrass ratings, reference can be had to A Guide to NTEP Turfgrass Ratings currently viewable on the world wide web at www.ntep.org, the discussion of which is incorporated herein by reference.

It is a feature of the composition of the present invention that it includes an amount of carbohydrate and an amount of an adjuvant blended together in an aqueous solution for mixing with water. It is the resultant mixture which is applied (as in a spray application) to the foliage of turfgrass. The carbohydrate of the mixture is preferably fructose, or even glucose, but it can be any of a number of carbohydrate sugars. The source of such a carbohydrate can be high fructose corn syrup, and corn syrup is known to blend well with water when mixed therewith. An example of a carbohydrate-rich commercial product is manufactured and sold under the trade designation IsoClear 55 from Cargill Inc. of Minneapolis, Minn. IsoClear 55 is comprised principally of glucose and fructose (i.e. about 55 percent glucose and 25 percent fructose).

Within the composition of the invention, the adjuvant is intended to reduce the surface tension of water and is believed to help move chemicals (i.e. in this case, the carbohydrates) into the foliage of the turfgrass. In any event, the adjuvant enhances the absorption of the carbohydrates by the leaves and sheath of the turfgrass. Any of a number of adjuvants are suitable for use in the composition of the present invention, but the preferred adjuvant is any organo-silicone surfactant. An example of an organo-silicone surfactant is available under the trade designation Break-Thru from Goldschmidt Chemical Corporation having offices in Hopewell, Va.

As mentioned earlier, the carbohydrates and the adjuvant are mixed with water to render the resultant (aqueous) mixture suitable for application to the foliage of the turfgrass. It is envisioned that the composition is most practically applied to the turfgrass with spray equipment having a spray nozzle which atomizes the mixture as the mixture exits the nozzle, but the composition can also be applied to the turfgrass by way of an irrigation system which broadcasts water in a spray across the top of the turfgrass. Accordingly and in the interests of the present invention, the term “spray-application” of the composition, or more specifically, the resulting aqueous mixture of water, carbohydrates and adjuvant, to the leaves of turfgrass is intended to cover any method for broadcasting the mixture in droplets over the top of the turfgrass so that the mixture gravitationally settles in droplets upon the leaves and sheath of the turfgrass.

As far as the various amounts of the carbohydrates needed to help stressed turfgrass is concerned, it is believed that such amounts can be best be expressed in the amount of carbohydrates used per acre. In this connection, we recommend that carbohydrates be mixed with water and applied to the turfgrass within the range of between about 0.1 gallon to 10 gallons per acre. The lower limit within this range is relatively small because even a small amount of carbohydrates which is applied to turfgrass can be helpful toward recovery from stress, but the upper limit of the range has been set to avoid further damage to the stressed turfgrass. In other words, we have found that if too much carbohydrates is applied to the turfgrass, the turfgrass will experience characteristics of burn. Accordingly, the upper limit of 10 gallons per acre ensures that the turfgrass to which the composition of the invention is applied will not be damaged by exposure to an excess amount of carbohydrates.

As far as the amount of adjuvant in the composition (or resulting mixture with water) is concerned, it has been found that adjuvant comprising 0.1 percent of the resulting mixture is a satisfactory amount for purposes of the present invention. In other words, about 0.1 gallons (or roughly about one pint) of adjuvant can be added to the mixture for every 100 gallons of water in the mixture. However, the smaller the amount of water in the mixture applied per acre of turfgrass, the greater the percentage amount of surfactant (by volume) should be used. Accordingly, an amount of surfactant within the range of between 0.1 to 5 percent volume to volume in the resulting mixture with water yields satisfactory results.

A description of our field experiments are provided here as follows:

In particular, field experiments were initiated in a summer month on turfgrass being grown on two separate putting greens at a nearby golf course. (Consequently, the type of stress to which the turfgrass was exposed was a heat-induced stress, i.e. an example of a condition of stress which inhibits net photosynthesis of the turfgrass.) The putting greens included a mixed stand of Penncross creeping bentgrass and annual bluegrass. Annual bluegrass was composed of annual and perennial varieties and infested approximately 60 percent of the putting green. Putting green maintenance schedules for the summer were the same throughout the summer and were as follows:

The greens were maintained at a height of about 3 mm daily; the greens were fertilized monthly with granular fertilizer (24 kg N/ha) and every other week (biweekly) with liquid fertilizer (5 kg N/ha) applications. Chlorothalonil (9.2 kg ai/ha) or fosetyl-Al+iprodione (4.5+3.1 kg ai/ha) were applied biweekly in rotation to prevent fungi growth. Trinexapac-ethyl (0.4 L/ha or 0.1057 L/ha) was applied every three weeks to reduce annual bluegrass and creeping bentgrass growth. The maintenance of this experimental area was uniform across all plots and is typical for a bentgrass green in the transition zone.

Applications were made twice weekly, weekly and every other week with high fructose and glucose concentrations (i.e. IsoClear) and organo-silicone surfactant at 2.27 percent and 0.1 percent, respectively, volume/volume (V/V), which amounted to about 6.8 L/A (1.797 gal/A) and 0.3 L/A (0.0793 gal/A) respectively. Treatments were applied to 1.5 by 3 meter plots in 303 L/A (80 gal/A) of water carrier with a backpack sprayer and were arranged in a randomized complete block design with four replications. Treatments were evaluated every two weeks to determine putting green color and quality (e.g. color, density and playability). Putting green color was visually evaluated on the aforedescribed NTEP scale of 1 to 9, with 1 indicating brown turf (e.g. putting green death) and 9 indicating the darkest green color (i.e. the highest quality putting green). A minimum acceptable rating for quality is 6.

SAS (1999) Proc Mixed was utilized to perform analysis of variance. Data were normally distributed with equal variance and arcsin square root transformation of putting green color and quality data did not affect conclusions and untransformed means are presented. There were no trial interactions and weeks data were taken were not significant therefore date were pooled across studies and weeks and means were separated using Fisher's Protected LSD (least significant difference) at the 0.10 level of probability.

Table 1 below sets forth the results (i.e. based upon the aforedescribed NTEP scale) of the overall bentgrass quality and color of the putting green after high fructose corn syrup and organo-silicone adjuvant are applied at 2.27 percent and 0.1 percent, respectively, volume/volume (V/V) delivered at 303 L/A (80 gal/A) in two locations.

TABLE 1

| Treatment interval | Quality | Color |
|---|---|---|
| Untreated | 6.9b | 6.9b |
| Twice Weekly | 7.7a | 7.8a |
| Weekly | 7.8a | 7.9a |
| Every Other Week | 7.1b | 7.4ab |
| LSD (0.10) | 0.4 | 0.8 |

For the results of Table 1, quality and color are averaged means taken about 3 weeks apart from the two locations on the putting green. Putting green quality was evaluated on a scale of 1-9, wherein 1 indicates putting green death and 9 indicates the highest quality putting green with a minimum acceptable rating of 6. Putting green color was evaluated on a scale of 1-9, wherein 1 indicates a brown color and 9 indicates the darkest green color possible for the turfgrass involved.

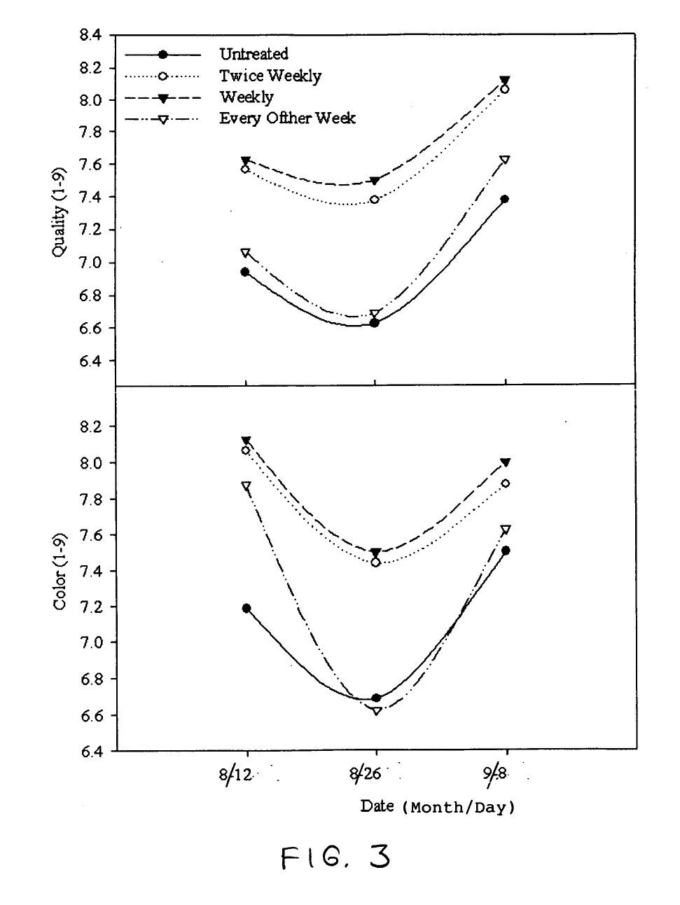

The results of the Table 1 are graphed in FIG. 3.

It can be concluded from the graphed results of FIG. 3 that subsequent applications of the composition to turfgrass enhanced the turf quality and color. Furthermore, the results yielded in the treated plots were better than in the untreated plots.

It will be understood that numerous modifications and substitutions can be had to the aforedescribed embodiment without departing from the spirit of the invention. Accordingly, the aforedescribed embodiment is intended for the purpose of illustration and not as limitation.

1. A composition for mixing with water for application to turfgrass experiencing or expected to experience stress-inducing conditions which inhibit naturally-occurring carbohydrate synthesis or reserves in the turfgrass, the composition comprising:
a carbohydrate; and
an adjuvant for enhancing the absorption of the carbohydrate by the leaves and sheath of the turfgrass
so that when the carbohydrate and adjuvant are mixed with water for application to the turfgrass, the carbohydrate can be applied to the turfgrass at the rate of between about 0.1 gallons and 10 gallons per acre.

2. The composition as defined in claim 1 wherein the carbohydrate is comprised primarily of glucose and fructose.

3. The composition as defined in claim 2 wherein the glucose comprises about 55% of the carbohydrate, by weight, and the fructose comprises about 45% of the carbohydrate, by weight.

4. The composition as defined in claim 2 wherein the adjuvant is an organo-silicone surfactant.

5. The composition as defined in claim 1 for mixing with about 100 gallons of water wherein the amount of carbohydrate in the mixture ranges from between about 1 pint to about 3.0 gallons.

6. The composition as defined in claim 5 and wherein the amount of adjuvant in the mixture is between about 0.5 pints and 1.5 pints.

7. The composition as defined in claim 1 which when mixed with water for application to the turfgrass experiencing appreciable stress, is adapted to be spray-applied to the turfgrass.

8. The composition as defined in claim 1 wherein the stressed condition which the turfgrass experiences or is expected to experience is a heat-induced stress.

9. A method of enhancing the growth of turfgrass, experiencing or expected to experience stress, the method comprising the steps of:
providing a carbohydrate;
providing an adjuvant for enhancing the absorption of the carbohydrate by the leaves and sheath of the turfgrass;
mixing the carbohydrate and adjuvant with an amount of water; and
spray-applying the mixture of carbohydrate, adjuvant and water to the turfgrass, under appreciable stress, so that the rate at which the carbohydrate of the mixture which is applied to the turfgrass in this step is between about 0.1 gallons to 10 gallons per acre.

10. A method as defined in claim 9 wherein the step of spray-applying the mixture to the turfgrass applies the carbohydrate of the mixture to the turfgrass at a rate of between about 0.1 to 2.0 gallons per acre.

11. The method as described in claim 9 wherein the provided carbohydrate is comprised primarily of glucose and fructose.

12. The method as described in claim 9 wherein the provided adjuvant is an organo-silicone surfactant.

13. The method as described in claim 9 wherein the amount of the provided adjuvant contained within the mixture is within the range of between 0.1 to 5 percent volume to volume.

14. A method for enhancing the growth of turfgrass, experiencing or expected to experience stress, the method comprising the steps of:
providing an amount of water;
providing an amount of carbohydrate;
providing an amount of adjuvant for enhancing the absorption of the carbohydrate by the leaves and sheath of the turfgrass;
mixing the amounts of carbohydrate and adjuvant with the amount of water; and
spray-applying the mixture of carbohydrate, adjuvant and water to the turfgrass at a rate of between about 0.1 and 10 gallons per acre of carbohydrate.

15. The method as defined in claim 14 wherein the step of spray-applying the mixture to the turfgrass so that the rate at which the carbohydrate of the mixture which is applied to the turfgrass in this step is between about 0.1 to 2.0 gallons per acre.

16. The method as described in claim 14 wherein the provided carbohydrate is comprised primarily of glucose and/or fructose.

17. The method as described in claim 14 wherein the provided adjuvant is an organo-silicone surfactant.

18. The method as described in claim 14 wherein the amount of the provided adjuvant contained within the mixture is within the range of between 0.1 to 5 percent volume to volume.

19. The method as described in claim 14 wherein the turfgrass to which the mixture of carbohydrate, adjuvant and water is applied has a NTEP rating scale number of no less than 2.
